(19) United States
(12) Patent Application Publication
(10) Pub. No.: US 2026/0262714 A1
(43) Pub. Date: Sep. 10, 2026

(54) Housing Portion, Aerosol Generation Device, and Method

(71) Applicant: JT International SA, Geneva (CH)

(72) Inventor: Claude Zominy, Copponex (FR)

(73) Assignee: JT International SA, Geneva (CH)

(21) Appl. No.: 19/164,818

(22) PCT Filed: Mar. 27, 2024
(86) PCT No.: PCT/EP2024/058265

§ 371 Date: Sep. 12, 2025

(30) Foreign Application Priority Data
Mar. 28, 2023 (EP) 23164711.6

(51) Int. Cl. A24F 40/40; A24F 40/10; A24F 40/85

(52) U.S. Cl. CPC A24F 40/40; A24F 40/10; A24F 40/85

(57) ABSTRACT

An aerosol generation device includes: an electronic component arrangement; a first conductive element arrangement electrically connected to the electronic component arrangement; a second conductive element arrangement electrically connected to the electronic component arrangement, and a housing portion including a conductive member arrangement formed as an integral part of the housing portion, wherein the conductive member arrangement is configured to provide an electrical connection between the first conductive element arrangement and the second conductive element arrangement, such that removal of the housing portion disconnects the electrical connection.

The present disclosure relates to a housing portion, in particular to a housing portion for an aerosol generation device. The present disclosure further relates to an aerosol generation device, and to a method.

### BACKGROUND

Battery cell recycling is a recycling activity that aims to reduce the number of battery cells being disposed alongside regular household waste. Battery cells contain heavy metals and toxic chemicals and disposing of them by the same process as regular household waste has raised concerns over soil contamination and water pollution. Furthermore, battery cell recycling can help to prevent a future shortage of battery cell materials and to enable a sustainable life cycle of these technologies.

An aerosol generation device is configured to heat an aerosol substrate to generate aerosol for inhalation. An aerosol generation device includes a power supply in the form of a battery cell. The battery cell provides power for operation of the aerosol generation device, and for example may provide the necessary power to generate aerosol. It may be desirable to access the battery cell, for replacement and/or recycling.

An aerosol generation device typically comprises a multitude of electrical connections. Electrical connections are provided between components of the aerosol generation device, and also to provide connection capability with auxiliary devices.

Routing electrical connections is often problematic due to space limitations within conventional aerosol generation devices.

Furthermore, replacement and recycling of components of the aerosol generation device (in particular, a battery cell) is often complex due to the electrical connections within the device. Additionally, accessing the battery cell presents a safety risk to the person performing disassembly. Dangers associated with extraction of the battery cell include electrical, chemical, and thermal dangers, and their potential interactions.

It is the object of the invention to overcome at least some of the above referenced problems, or problems referenced elsewhere.

### SUMMARY

According to the present disclosure there is provided a housing portion, an aerosol generation device, and a method, including the features as set out in the claims.

According to a first aspect of the present invention, there is provided a housing portion for an aerosol generation device, the aerosol generation device comprising: an electronic component arrangement; a first conductive element arrangement electrically connected to the electronic component arrangement; and a second conductive element arrangement electrically connected to the electronic component arrangement, the housing portion comprising a conductive member arrangement formed as an integral part of the housing portion, wherein the conductive member arrangement is configured to provide an electrical connection between the first conductive element arrangement and the second conductive element arrangement, removal of the housing portion disconnects the electrical connection.

In this way, electrical connection may be (e.g. selectively) provided by provision of the housing portion itself. It will be appreciated that this is because the conductive member arrangement is formed as an integral part of the housing portion. Throughout the description herein, this may be referred to as the conductive member arrangement being “of” the housing portion. This construction is in contrast to a typical electrical connection arrangement requiring internal, permanent, or more dedicated electrical connection elements (e.g., electrical wiring separated from any device housing, which will be appreciated not to be integral to the housing portion) to form connections to or between electrical components. Instead, in the present invention, electrical connection to or between the one or more electronic components is provided by the housing portion. For avoidance of doubt, the housing portion is not simply covering, or housing, a conductive member arrangement (e.g., conventional wiring), but is itself providing the electrical connection by the integrally formed conductive member arrangement. It will be appreciated that, by the present construction, an electrical connection is provided with the electronic component arrangement by the conductive member arrangement of the housing portion.

This is highly advantageous in increasing the amount of available space in the aerosol generation device and/or reducing the size of the aerosol generation device.

Furthermore, by such a construction, the process of accessing, replacing and recycling components of the aerosol generation device may be simplified. This is because fewer electrical connection elements need be provided in the device. Moreover, as the housing portion provides the electrical connection, removal of the housing portion results in a disconnection of an electrical connection. This improves safety in accessing components of the aerosol generation device, as a result of the electrical connection being broken, opened, or disconnected, when the housing portion is removed. This might also improve safety or anticounterfeiting, because the conductive element may serve as a key or switch for operation of the device. If a cover is used that does not have the conductive element, the device may not function as intended, or at all.

Additionally, the housing portion may facilitate connection of an auxiliary device to the aerosol generation device. The function of the aerosol generation device may thereby be augmented in some way by connection of the auxiliary device. A system may be provided, wherein the system comprises the aerosol generation device as described herein and the auxiliary device. The electronic component arrangement of the aerosol generation device may comprise an electronic component. It may be desired to form an electrical connection with the electronic component from outside of (e.g., external to) the aerosol generation device. The auxiliary device may be electrically connected to the electronic component of the aerosol generation device, via the conductive member arrangement of the housing portion. That is, the auxiliary device may be electrically connected to the conductive member arrangement of the housing portion.

As will be described in greater detail below, the auxiliary device may be a discharge device, for discharging a battery cell of an aerosol generation device. The auxiliary device may comprise a first auxiliary device component. The first auxiliary device component may be a component arranged to receive (or draw) electrical power from the aerosol generation device. The auxiliary device may be connectable to the conductive member arrangement of the housing portion to discharge a battery cell of the aerosol generation device via the first auxiliary device component.

In relation to the above, in other words, the housing portion may be said to comprise an integrally formed conductive member arrangement. The housing portion may be said to be configured to provide the electrical connection, as it will be appreciated that the conductive member arrangement provides the electrical connection and the conductive member arrangement is integral to the housing portion. The housing portion may be configured to be removed to disconnect the electrical connection. The housing portion may be readily removable (e.g., removably or releasably mountable).

In one example, the housing portion may be configured to be removable from connection with the aerosol generation device thereby to disconnect the electrical connection, e.g., by removal of the integrally formed conductive member arrangement.

Advantages of this construction will be appreciated from the above, but it is important to note that such a construction ensures user safety, as removal of the housing portion (and, as a result, the integrally formed conductive member arrangement) disconnects an electrical connection (which may be the provision of electrical power to components of the aerosol generation device). In this way, it may be ensured that the electrical connection, or supply of electrical power, is disconnected and/or terminated by removal of the housing portion. As will be appreciated from the below, removal of the housing portion may expose electrical components, and so disconnecting the electrical connection or terminating provision of power when the housing portion is removed is highly advantageous. Removal of the housing portion may be by the housing portion being removably (or releasably) attachable, connectable, or mountable at or on the aerosol generation device, as described in further detail below. The housing portion may be an outer cover, e.g., covering or providing an outer surface or face of the aerosol generation device.

In one example, the electronic component arrangement comprises a first electronic component and a second electronic component, the first conductive element arrangement is electrically connected to the first electronic component, and the second conductive element arrangement is electrically connected to the second electronic component, wherein the conductive member arrangement of the housing portion is configured to be connected between the first conductive element arrangement and the second conductive element arrangement, such that an electrical connection is provided between the first electronic component and the second electronic component by the conductive member arrangement of the housing portion.

That is, the electrical connection may be between a plurality of electronic components of the aerosol generation device. That is, the first and second electronic components may be components of the aerosol generation device. In this way, an electrical connection between electronic components of the aerosol generation device can be provided by the housing portion.

In one example, the first electronic component is a power supply or a component to be provided with electrical power from the power supply and/or the second electronic component is a power supply or a component to be provided with electrical power from the power supply.

Where the first electronic component is a power supply and the second electronic component is a power supply, the electrical connection may be between the power supplies such that a power supply system can be formed, for provision of electrical power to the aerosol generation device or to an auxiliary device. Where the first electronic component is a power supply and the second electronic component is a component to be provided with electrical power from the power supply, or vice versa, the electrical connection facilitates the provision of electrical power from the power supply to said component. As above, this is highly advantageous, in terms of a simpler, more robust construction, and improving safety in disassembly. In particular, the provision of electrical power to said component may be terminated by removal of the housing portion.

In one example, the first conductive element arrangement comprises a first pair of conductive elements, the second conductive element arrangement comprises a second pair of conductive elements, the conductive member arrangement comprising a pair of conductive members, wherein: a first one of the pair of conductive members is connectable between a first one of the first pair of conductive elements and a first one of the second pair of conductive elements; and a second one of the pair of conductive members is connectable between a second one of the first pair of conductive elements and a second one of the second pair of conductive elements.

In this way, a robust electrical connection can be formed between the first electronic component and second electronic component. Removal of at least one of the pair of conductive members (e.g., by removal of the housing portion) results in an electrical disconnection.

In one example, the housing portion is removably locatable in relation to the aerosol generation device and/or is removably attachable to the aerosol generation device.

In this way, the housing portion when installed provides an electrical connection with the electronic component arrangement by the conductive member arrangement of the housing portion. However, and highly advantageously, by removal of (e.g., detachment of) the housing portion, the electrical connection can be disconnected (e.g., terminated) when the conductive member arrangement is removed by removal of (e.g., detachment of) the housing portion. That is, the electrical circuit can be opened by removal of the housing portion. This improves safety in disassembly of the aerosol generation device, as, in an example, a power supply is simultaneously disconnected when the housing portion is removed to access the components within the aerosol generation device. The housing portion may be removably locatable in, or on, the aerosol generation device.

In one example, the conductive member arrangement of the housing portion is configured to form a part of an electrical circuit of the aerosol generation device.

In this way, an electrical circuit is formable by providing the housing portion. Conversely, the electrical circuit may be broken, or opened, or disconnected, by removal of the housing portion. This is highly advantageous, as the provision of electrical current between components of the aerosol generation device can be terminated by removal of the housing portion, thus improving safety in accessing components of the aerosol generation device.

In one example, the conductive member arrangement of the housing portion is configured to form a part of an electrical circuit of a battery module of the aerosol generation device.

In this way, the provision of power from the battery module to other components of the aerosol generation device or of the battery module itself may be terminated by removal of the housing portion.

In one example, the housing portion forms part of the battery module of the aerosol generation device.

This may simplify construction, as the housing portion can be formed as part of the battery module of the aerosol generation device. The housing portion may be integrally formed with the battery module.

In one example, the conductive member arrangement of the housing portion is configured to provide the electrical connection to enable operation of one or more components of the electronic component arrangement of the aerosol generation device. In this way, when the housing portion is provided the one or more electronic components of the aerosol generation device are operable, or functional, whereas non-provision (or removal) of the housing portion may terminate operation of the one or more electronic components of the aerosol generation device. This may allow the entire aerosol generation device to operate, or cease operation, depending on whether the housing is provided.

In one example, the housing portion is locatable in relation to the aerosol generation device to close or cover an outer surface, or part of an outer surface, of the aerosol generation device.

In this way, removal of the housing portion (which, doing so, may expose electrical components) results in the disconnection of the electrical connection. Safety is thereby improved. Furthermore, this provides a simplified manner for disconnecting the electrical connection. Further advantages include increasing the amount of available space in the aerosol generation device and/or reducing the size of the aerosol generation device.

In one example, the housing portion comprises a transparent or semi-transparent layer through which the conductive member arrangement is visible.

By such a construction, assembly of the aerosol generation device may be simplified as the conductive elements to which the conductive member arrangement is to connect to can be seen so as to be accurately located by a user or manufacturer. This may also improve safety.

According to a second aspect of the present invention, there is provided an aerosol generation device comprising the housing portion according to the first aspect of the present invention.

The second aspect of the present invention may incorporate any or all of the features of the first aspect of the present invention, as desired or as appropriate.

According to a third aspect of the present invention, there is provided an aerosol generation device comprising: an electronic component arrangement; a first conductive element arrangement electrically connected to the electronic component arrangement; a second conductive element arrangement electrically connected to the electronic component arrangement; and a housing portion comprising a conductive member arrangement formed as an integral part of the housing portion, wherein the conductive member arrangement is configured to provide an electrical connection between the first conductive element arrangement and the second conductive element arrangement, such that removal of the housing portion disconnects the electrical connection.

As discussed above in relation to the first aspect, such a construction is highly advantageous as electrical connection is provided by provision of the housing portion itself. It will be appreciated that this is because the conductive member arrangement is formed as an integral part of the housing portion. Throughout the description herein, this may be referred to as the conductive member arrangement being “of” the housing portion. This is in contrast to typical electrical connection arrangement requiring electrical connection elements (e.g., electrical wiring separated from any device housing, which will be appreciated not to be integral to the housing portion) to form connections to or between electrical components of the aerosol generation device. Instead, in the present invention, electrical connection to or between the one or more electronic components is provided by the housing portion. For avoidance of doubt, as mentioned above the housing portion is not simply covering, or housing, a conductive member arrangement (e.g., conventional wiring), but is itself providing the electrical connection by the integrally formed conductive member arrangement. It will be appreciated that, by the present construction, an electrical connection is provided with the electronic component arrangement by the conductive member arrangement of the housing portion.

As discussed above, available space in the aerosol generation device can thus be increased and/or overall size of the aerosol generation device reduced. Furthermore, by such a construction, the process of accessing, replacing and recycling components of the aerosol generation device may be simplified. This is because fewer electrical connection elements need be provided in the device. Moreover, as the housing portion provides the electrical connection, removal of the housing portion results in a disconnection of an electrical connection. This improves safety in accessing components of the aerosol generation device, as a result of the electrical connection being broken, opened, or disconnected, when the housing portion is removed. This might also improve safety or anticounterfeiting, because the conductive element may serve as a key or switch for operation of the device. If a cover is used that does not have the conductive element, the device may not function as intended, or at all.

The third aspect of the present invention may incorporate any or all of the features of the first and/or second aspect of the present invention, as desired or as appropriate.

In one example, the electronic component arrangement comprises a first electronic component and a second electronic component, the first conductive element arrangement electrically connected to the first electronic component; and the second conductive element arrangement electrically connected to the second electronic component, wherein the conductive member arrangement is configured to be connected between the first conductive element arrangement and the second conductive element arrangement, such that an electrical connection is provided between the first electronic component and the second electronic component by the conductive member arrangement of the housing portion.

According to a fourth aspect of the present invention, there is provided a method of providing an electrical connection with an electronic component arrangement of an aerosol generation device, the aerosol generation device comprising: an electronic component arrangement; a first conductive element arrangement electrically connected to the electronic component arrangement; and a second conductive element arrangement electrically connected to the electronic component arrangement. The method comprises configuring a conductive member arrangement formed as an integral part of a housing portion to provide an electrical connection between the first conductive element arrangement and the second conductive element arrangement.

Thus, an electrical connection is provided by provision of the housing portion. This is highly advantageous, as will be understood from the advantages above and the description provided herein.

In one example, the method comprising providing the aerosol generation device.

The fourth aspect of the present invention may incorporate any or all of the features of the first, second and/or third aspect of the present invention, as desired or as appropriate.

According to a fifth aspect of the present invention, there is provided a method of disconnecting (e.g., removing) an electrical connection in an aerosol generation device, the aerosol generation device comprising: an electronic component arrangement; a first conductive element arrangement electrically connected to the electronic component arrangement; and a second conductive element arrangement electrically connected to the electronic component arrangement. The method comprises removing a housing portion of the aerosol generation device, the housing portion comprising a conductive member arrangement formed as an integral part of the housing portion and configured to provide an electrical connection between the first conductive element arrangement and the second conductive element arrangement, thereby to disconnect the electrical connection.

Thus, an electrical connection is removable by removal of the housing portion. This is highly advantageous, as will be understood from the advantages above, in particular in relation to the first and second aspects, and the description provided herein.

In one example, the method comprising providing the aerosol generation device.

The fifth aspect of the present invention may incorporate any or all of the features of the first, second, third and/or fourth aspect of the present invention, as desired or as appropriate.

### BRIEF DESCRIPTION OF THE DRAWINGS

Examples of the present disclosure will now be described with reference to the accompanying drawings.

FIG. 1 shows an aerosol generation device;

FIG. 2 shows a cross section of the aerosol generation device of FIG. 1 viewed along line A-A in the direction of the arrows;

FIG. 3 shows a cross section view of the aerosol generation device of FIG. 1 viewed along line B-B in the direction of the arrows;

FIG. 4 shows a system;

FIG. 5 shows general methodology principles;

FIG. 6 shows general methodology principles; and

FIG. 7 shows an aerosol generation device.

### DETAILED DESCRIPTION

As used herein, the term “aerosol precursor material”, “vapour precursor material” or “vaporizable material” are used synonymously and may refer to a material and/or composition, which may for example comprise nicotine or tobacco and a vaporising agent. The aerosol precursor material is configured to release an aerosol when heated or otherwise mechanically stimulated (such as by vibrations). Tobacco may take the form of various materials such as shredded tobacco, granulated tobacco, tobacco leaf and/or reconstituted tobacco. Nicotine may be in the form of nicotine salts. Suitable vaporising agents include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some examples, the aerosol precursor material is substantially a liquid that holds or comprises one or more solid particles, such as tobacco. An aerosol generation device is configured to aerosolise an aerosol precursor material without combustion in order to facilitate delivery of an aerosol to a user. Furthermore, and as is common in the technical field, the terms “vapour” and “aerosol”, and related terms such as “vaporize”, “volatilize” and “aerosolise”, may generally be used interchangeably.

As used herein, the term “aerosol generation device” is synonymous with “aerosol generating device” or “device” may include a device configured to heat an aerosol precursor material and deliver an aerosol to a user. The device may be portable. “Portable” may refer to the device being for use when held by a user. The device may be adapted to generate a variable amount of aerosol, which can be controlled by a user input.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

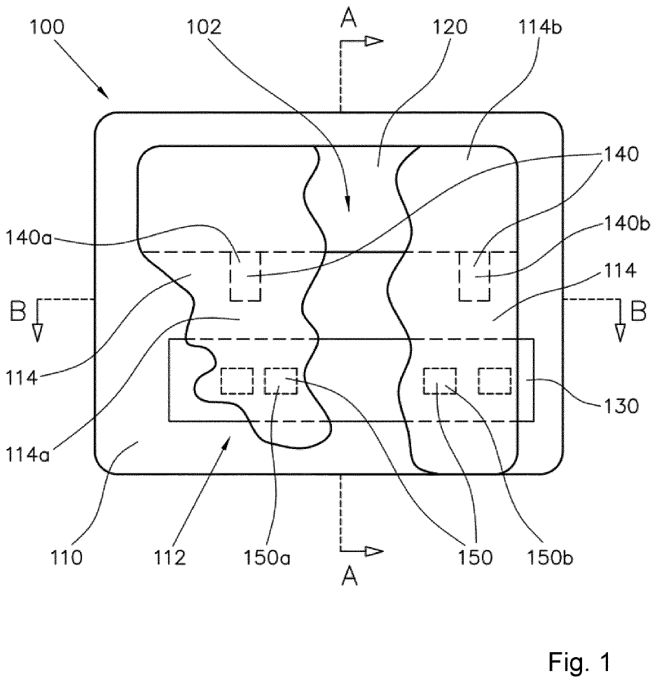

Referring to FIG. 1, an aerosol generation device 100 is shown in plan view. The outline of components which are hidden or obscured by other components are indicated in FIG. 1 in dashed lines.

The aerosol generation device 100 comprises a housing 110. In this example, the housing 110 is the entire housing of the aerosol generation device 100. That is, the housing 110 may surround the aerosol generation device 100, housing the components of the aerosol generation device 100 within.

The housing 110 comprises a housing portion 112. The housing portion 112 is an important feature of the present invention. The housing portion 112 is for the aerosol generation device 100. That is, the housing portion 112 may be for attachment to the aerosol generation device 100. The housing portion 112 may be a portion of the housing 110 (e.g., a part or portion of the outer surround of the aerosol generation device 100). Additionally, or alternatively, the housing portion 112 may be a housing component, section, or piece of a housing, such as a cover. The housing portion 112 may be a greater or lesser part of the housing 110 (i.e., the housing portion 112 may provide more or less than half of the overall surface area of the housing 110). The housing portion 112 may be removable to gain access to internal components of the aerosol generation device 100.

Importantly, and as discussed in greater detail below, the housing portion 112 comprises a conductive member arrangement 114. The conductive member arrangement 114 is connectable in the aerosol generation device 100 to provide an electrical connection therein. That is, the conductive member arrangement 114 is configured to provide the electrical connection.

As will be appreciated from the description herein and the advantages of providing an electrical connection “using the housing portion 112”, the conductive member arrangement 114 is formed as an integral part of the housing portion 112. Throughout the description herein, this may be referred to as the conductive member arrangement 114 being “of” the housing portion 112. In other words, the housing portion 112 and conductive member arrangement 114 are integrally formed. The conductive member arrangement 114 and housing portion 112 may be formed as a single piece, or may be “one-piece formed”. The housing portion 112 and conductive member arrangement 114 may be formed during a single process, for example by additive layer manufacturing. Alternatively, the conductive member arrangement 114 may be attached to the housing portion 112, e.g., a separate conductive member arrangement 114 connected to, and supported by, the housing portion 112. The housing portion 112 may comprise a recess, and the conductive member arrangement 114 embedded in the housing portion 112. It will be appreciated that the conductive member arrangement 114 may be embedded in the housing portion 112, for example by providing said conductive member arrangement 114 in a recess in the housing portion 112, or by a different manner of construction as will be appreciated by the skilled person. The conductive member arrangement 114 may be provided as a separate layer on the housing portion 112, for example on an inwardly facing side of the housing portion 112. This may enable electrical connection to be provided when the housing portion 112 is connected, or attached, to the aerosol generation device 100.

A key feature of the present invention is that the conductive member arrangement 114 is an integral part of the housing portion 112, so that removal of the housing portion 112 disconnects the electrical connection. It will be understood that removal of the housing portion 112 removes the conductive member arrangement 114, by virtue of the integral construction, thereby resulting in the disconnection of the electrical connection, and/or a termination in provision of electrical power between electrical components.

Providing an electrical connection using the housing portion 112 is highly advantageous. In this way, the housing portion 112 may replace, or mitigate the need for, additional electrical connections (e.g., wiring) within the aerosol generation device. This may simplify construction, maintenance, provide additional available space within the aerosol generation device 100, lead to a reduction in form factor of the aerosol generation device 100, be a more robust construction than electrical wiring, and reduce manufacturing costs.

A further important advantage is that by providing the electrical connection using the housing portion 112, removal of the housing portion 112 from attachment to the aerosol generation device 100 results in a disconnection of the electrical connection. In other words, removal of the housing portion 112 disconnects the electrical connection. This is highly beneficial in improving safety in replacement of aerosol generation device components, and in recycling processes.

Informally, a key feature of the present invention is the provision of electrical connection by provision of the housing portion 112 itself, rather than the incorporation of separate electrical connection elements (such as wiring or the like).

As will be appreciated from the above, but emphasised here, the housing portion 112 is not simply covering, or housing, the conductive member arrangement 114 (e.g., as in typical examples of aerosol generation devices which comprise housings which house conventional electrical connections, such as wiring connecting components), but is itself providing the electrical connection by the integrally formed conductive member arrangement 114. It will be appreciated that, by the present construction, an electrical connection is provided with an electronic component arrangement 102 (described further herein) by the conductive member arrangement 114 of the housing portion 112.

The conductive member arrangement 114 may comprise one or more electrically conductive members 114. The one or more conductive members 114 may be metallic members.

The housing portion 112 may be configured to provide an electrical connection with one or more electronic components of the aerosol generation device 100. The electrical connection may be provided by the conductive member arrangement 114, specifically by the one or more conductive members 114a, 114b.

The electrical connection may be formed between a plurality of components, thus providing electrical connection between them.

As will be described in a later example, the housing portion 112 providing an electrical connection with one or more electronic components of the aerosol generation device 100 may allow an auxiliary device (which may be an external device) to be electrically connected to the one or more electronic components by the auxiliary device connecting to the conductive member arrangement 114 of the housing portion 112.

The aerosol generation device 100 comprises an electronic component arrangement 102. The electronic component arrangement 102 may comprise a first electronic component 120. The electronic component arrangement 102 may further comprise a second electronic component 130.

The first electronic component 120 may be a power supply 120. In this example, the power supply 120 is a battery cell 120. The battery cell 120 may be a can cell, a soft pouch battery cell, or any other suitable type of battery cell.

The second electronic component 130 may be any electronic component other than the power supply 120. The second electronic component 130 may be a component to be provided with electrical power from the power supply 120. The second electronic component 130 is preferably a printed circuit board (PCB) 130. A plurality of PCBs may be provided, and the PCBs may be connected (e.g., electrically connected). The PCB 130, or PCBs, may form part of a processor of the aerosol generation device 100. Alternatively, the second electronic component 130 may be an additional power supply or battery cell.

The aerosol generation device 100 comprises a first conductive element arrangement 140. The first conductive element arrangement 140 is electrically connected to the electronic component arrangement. The first conductive element arrangement may comprise a first pair of conductive elements 140. In the example illustrated in FIG. 1, the first pair of conductive elements 140 are electrically connected to the first electronic component 120, which as above may be the power supply 120. The first pair of conductive elements 140 may comprise a first conductive element 140a electrically connected with a first terminal (e.g., a positive terminal) of the power supply 120. The first pair of conductive elements 140 may comprise a second conductive element 140b electrically connected with a second terminal (e.g., a negative terminal) of the power supply 120.

The first pair of conductive elements 140 may be provided in a battery module of the aerosol generation device 100. The battery module may comprise the battery cell 120. The first pair of conductive elements 140 may be tabs which are connected to the terminals of the battery cell 120.

The aerosol generation device 100 comprises a second conductive element arrangement 150. The second conductive element arrangement 150 is electrically connected to the electronic component arrangement. The second conductive element arrangement 150 may comprise a second pair of conductive elements 150. In the example illustrated in FIG. 1, the second pair of conductive elements 150 are electrically connected to the second electronic component 130, which as above may be a component 130 to be provided with electrical power from the power supply 120, such as a PCB 130. The second pair of conductive elements 150 may be provided on, or in, the electronic component 130. The second pair of conductive elements 150 may comprise a first conductive element 150a electrically connected with an electrical circuit of the second electronic component 130. The second pair of conductive elements 150 may comprise a second conductive element 150b electrically connected with the electrical circuit of the second electronic component 130.

As above, the housing portion 112 comprises a conductive member arrangement 114. The conductive member arrangement 114 is configured to be connected between the first conductive element arrangement 140 and the second conductive element arrangement 150, such that an electrical connection is provided (e.g., is providable) with the electronic component arrangement 102 by the conductive member arrangement 114 of the housing portion 112. As above, in this way, the housing portion 112 may replace, or mitigate the need for, additional electrical connections (e.g., wiring) within the aerosol generation device 100. This may simplify construction, maintenance, provide additional available space within the aerosol generation device 100, lead to a reduction in form factor of the aerosol generation device 100, be a more robust construction than electrical wiring, and reduce manufacturing costs. A further important advantage is that by providing the electrical connection using the housing portion 112, removal of the housing portion 112 from attachment to the aerosol generation device 100 results in a disconnection of the electrical connection. This is highly beneficial in improving safety in replacement of aerosol generation device components, and in recycling processes.

Also as discussed herein, such functionality might also serve as a key or anti-counterfeiting measure. If a different cover (e.g. counterfeit, or from a different supplier) is used that does not comprise the required conductive member, the aerosol generation device may not work as the original manufacturer intended, or not work at all.

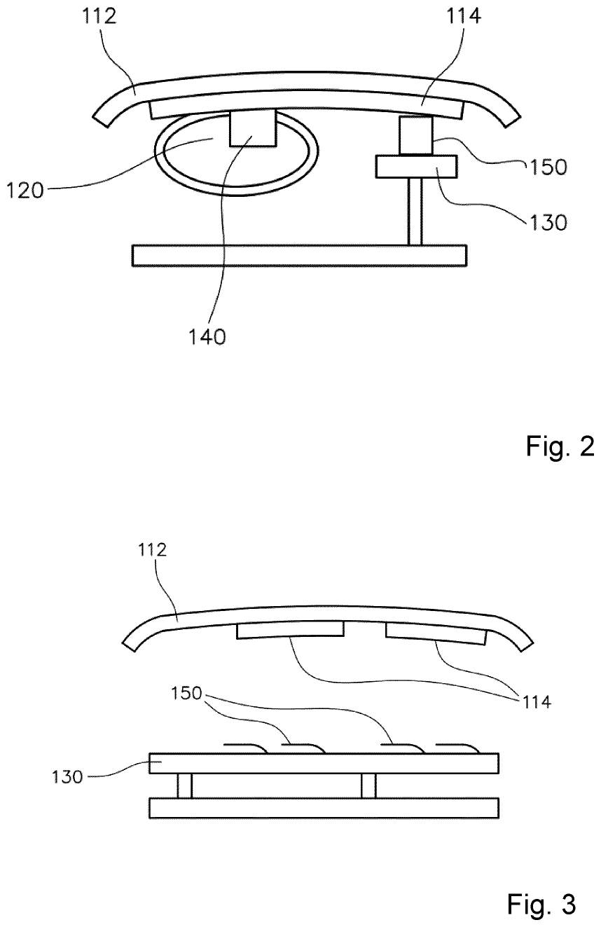

Referring to FIG. 2, a cross section view of the aerosol generation device of FIG. 1 is shown. The cross section is taken along the line A-A (as shown in FIG. 1) and viewed in the direction of the associated arrows.

The housing portion 112 can be seen in FIG. 2. The housing portion 112 extends over the first electronic component 120 and second electronic component 130. The conductive member arrangement 114 of the housing portion 112 provides an electrical connection between said components 120, 130. The first conductive member arrangement 140 and second conductive member arrangement 150 are shown in FIG. 2.

Referring to FIG. 3, a cross section view of the aerosol generation device of FIG. 1 is shown. The cross section is taken along the line B-B (as shown in FIG. 1) and viewed in the direction of the associated arrows.

The power supply 120 is not visible in FIG. 3. The second conductive element arrangement 150 is illustrate as contacting blades, tongues, or strips, projecting from (e.g., from a surface of) the second electronic component 130.

To aid understanding of the invention, reference is made to FIGS. 1, 2 and 3.

The conductive member arrangement 114 of the housing portion 112 may be configured to be connected between the first conductive element arrangement 140 and the second conductive element arrangement 150, such that an electrical connection is provided between the first electronic component 120 and the second electronic component 130 by the conductive member arrangement 114 of the housing portion 112.

In this way, the first electronic component 120 and second electronic component 130 can be electrically connected. The housing portion 112 provides said electrical connection, in contrast to conventional approaches involving providing wiring or other forms of electrical connection which do not form part of a housing of an aerosol generation device.

By the present construction, space in the aerosol generation device 100 may be made available for additional components or a reduction in form factor, and a more robust construction may be provided. Furthermore, highly advantageously, it will be appreciated that removal of the housing portion 112 results in a removal of the electrical connection. In this way, during disassembly of the aerosol generation device 100, the housing portion 112 may be removed to access components within said device, thus automatically disconnecting the electrical connection between the first electronic component 120 and the second electronic component 130.

The conductive member arrangement 114 may comprise a pair of conductive members 114a, 114b.

A first one of the pair of conductive members 114 (e.g., conductive member 114a) may be connectable between a first one of the first pair of conductive elements 140 (e.g., conductive element 140a) and a first one of the second pair of conductive elements 150 (e.g., conductive element 150a).

A second one of the pair of conductive members 114 (e.g., conductive member 114b) may be connectable between a second one of the first pair of conductive elements 140 (e.g., conductive element 140b) and a second one of the second pair of conductive elements 150 (e.g., conductive element 150b).

The conductive members 114 may be connectable by forming a contacting connection between the conductive members 114 and the respective conductive element 140, 150.

As above, the first one of the pair of conductive elements 140a may be electrically connected with the positive terminal of the power supply 120, and the second one of the pair of conductive elements 140b may be electrically connected with the negative terminal of the power supply 120. The first one of the second pair of conductive elements 150a may be electrically connected to the second electronic component 130 and the second one of the second pair of conductive elements 150b may be electrically connected to the second electronic component 130. Forming the electrical connection between the first one of the first pair of conductive elements 140a and the first one of the second pair of conductive elements 150a using the first one of the pair of conductive members 114a, and forming the electrical connection between the second one of the first pair of conductive elements 140b and the second one of the second pair of conductive elements 150b using the second one of the pair of conductive members 114b, enables an electrical circuit to be formed comprising the first electronic component 120, second electronic component 130, conductive elements 140, 150 and conductive members 114. Power or communication may thus be provided between the first electronic component 120 and second electronic component 130 using the housing portion 112.

Whilst the second conductive element arrangement 150 has been described to comprise a pair of conductive elements, it will be appreciated (in particular from FIGS. 1 and 3) that the second conductive element arrangement 150 may comprise further (e.g., more than two) conductive elements. In particular, the second conductive element arrangement 150 may comprise two pairs of (e.g., four) conductive elements. This may facilitate electrical connection to additional electronic components. That is, the second electronic component 130 may comprise a plurality of components, or sub-components, to be electrically connected to the first electronic component 120. This may be for the provision of electrical power (e.g., from a power supply 120).

Furthermore, whilst the conductive member arrangement 114 has been described to comprise a pair of conductive members 114a, 114b, it will be appreciated that the conductive member arrangement 114 may comprise further (e.g., more than two) conductive members 114, or, in particular, further pairs (e.g., more than one pair) of conductive members. In particular, additional conductive members may be provided to provide electrical connection between multiple first electronic components 120 and multiple second electronic components 130. In a specific example, a plurality of power supplies 120 may be provided, and a plurality of pairs of conductive members may be provided to electrically connect said power supplies 120 with second electronic components 130, in the manner herein described.

As best shown in FIG. 1, the conductive member arrangement 114 may have a large surface area. That is, the members 114a, 114b of the conductive member arrangement 114 have a greater surface area than the elements of the conductive element arrangements 140, 150 to which they connect or contact. The conductive members 114a, 114b may contact the entire surface of one or more, and preferable all, elements of the conductive element arrangements 140, 150. This may enable high electrical currents to be sustained, e.g., higher currents than may be sustained using typical electrical connections such as wiring, which do not connect so as to contact the entire surface of conductive elements. Alternatively, a larger surface area might make it easier to locate, or maintain connection with, the conductive member 114.

In an example, the housing portion 112 is removably locatable in relation to the aerosol generation device 100.

In this way, the housing portion 112 when installed provides an electrical connection with the electronic component arrangement 102 by the conductive member arrangement 114 of the housing portion 112. However, and highly advantageously, by removal of the housing portion 112, the electrical connection can be disconnected (e.g., terminated) when the conductive member arrangement 114 is removed by removal of the housing portion 112. That is, the electrical circuit can be opened by removal of the housing portion 112. This improves safety in disassembly of the aerosol generation device 100, as, in an example, the power supply 120 is simultaneously disconnected when the housing portion 112 is removed to access the components within the aerosol generation device 100.

The housing portion 112 may be removably locatable in, and/or removably attachable in or to, the aerosol generation device 100. It will be appreciated that the housing portion 112 may be locatable in the aerosol generation device 100 by being provided on the aerosol generation device 100, and may be to close a face (e.g., an outer surface or face), or to cover a surface (e.g., an outer surface or face) or a part of a surface (e.g., a part of an outer surface or face), of the aerosol generation device 100. This may be by removably or releasably attaching the housing portion 112 to the aerosol generation device 100. For example, the housing portion 112 may be removably or releasably attachable in, or to, the housing 110. The housing portion 112 may comprise a part of a releasable attachment mechanism and another part of the housing 110 or aerosol generation device 100 may comprise a corresponding part of a releasable attachment mechanism, wherein the parts are attachable or engageable to provide a releasable attachment of the housing portion 112 in the aerosol generation device 100.

In an example, the conductive member arrangement 114 of the housing portion 112 is configured to form a part of an electrical circuit of the aerosol generation device 100.

In this way, part of the electrical circuit is providable by the housing portion 112, and furthermore, part of the electrical circuit is removable by removal of the housing portion 112. This is highly advantageous as it provides a simple and robust manner in which the electrical circuit can be connected and disconnected, simply by provision or removal of the housing portion 112.

In a highly advantageous example, the conductive member arrangement 114 of the housing portion forms a part of an electrical circuit connecting to the power supply 120.

The housing portion 112 provides a safety feature, in that removal of the housing portion 112 results in an opening of the electrical circuit (which, for example, may be on the positive polarity of the battery cell 120). The housing portion 112 avoids a risk of short circuit during a process of replacement or removal of the battery cell. Removal of the housing portion 112 from the aerosol generation device 100 may cut the positive pole of the electrical circuit.

In an example, the conductive member arrangement 114 of the housing portion 112 is configured to form a part of an electrical circuit of a battery module of the aerosol generation device 100.

In this way, the provision of power from the battery module to other components of the aerosol generation device 100 or of the battery module itself may be terminated by removal of the housing portion 112.

In an example, the housing portion 112 forms part of the battery module of the aerosol generation device 100.

The housing portion 112 may be formed with (e.g., integrally formed with or integral to) the battery module. That is, the housing portion 112 may have one or more battery module components formed thereon, or attached thereto. Removal of the housing portion 112 thus results in a removal of one or more battery module components. For example, a battery cell 120 may be attached to the housing portion 112. Furthermore, the housing portion 112 may form a housing of the battery cell 120.

The battery module may comprise one or more battery module components. The battery module may be for connection to the aerosol generation device 100 for providing power thereto. The battery module may comprise the power supply 120, specifically the battery cell 120. The battery module may comprise a battery module hardware protection system. The battery module hardware protection system may comprise a fuse and/or a protection integrated circuit (IC) module. The battery module hardware protection system may comprise an interface (e.g., a user interface).

The conductive member arrangement 114 of the housing portion 112 may be configured to form a part of an electrical circuit of a battery module by providing an electrical connection between the above described one or more battery module components.

In an example, the conductive member arrangement 114 of the housing portion 112 is configured to provide the electrical connection to enable operation of one or more components of the electronic component arrangement 102 of the aerosol generation device 100.

Providing the electrical connection to enable operation of one or more components of the electronic component arrangement 102 using the housing portion 112 is highly advantageous. In this way, the housing portion 112 may replace, or mitigate the need for, additional electrical connections (e.g., wiring) within the aerosol generation device. This may simplify construction, maintenance, provide additional available space within the aerosol generation device 100, lead to a reduction in form factor of the aerosol generation device 100, be a more robust construction than electrical wiring, and reduce manufacturing costs.

A further important advantage is that by such a construction, removal of the housing portion 112 from attachment to the aerosol generation device 100 may terminate operation of one or more components of the electronic component arrangement 102. This is highly beneficial in improving safety in replacement of aerosol generation device components, and in recycling processes.

In an example, the housing portion 112 comprises a transparent or semi-transparent layer. The conductive member arrangement 114 of the housing portion 112 may be visible through the transparent or semi-transparent layer.

By such a construction, assembly of the aerosol generation device 100 may be simplified as the conductive elements 140, 150 to which the conductive member arrangement 114 is to connect to can be seen so as to be accurately located. This may also improve safety.

In an example, the conductive member arrangement 114 of the housing portion 112 may be accessible (e.g., selectively accessible) from outside of the aerosol generation device 100. A part of the housing portion 112 may be removable to access the conductive member arrangement, e.g., below said part of the housing portion 112. The conductive member arrangement 114 may be accessible through an opening in the housing portion 112. In this way, an auxiliary device may be connectable to the conductive member arrangement 114. Advantages of the auxiliary device will be understood from the below.

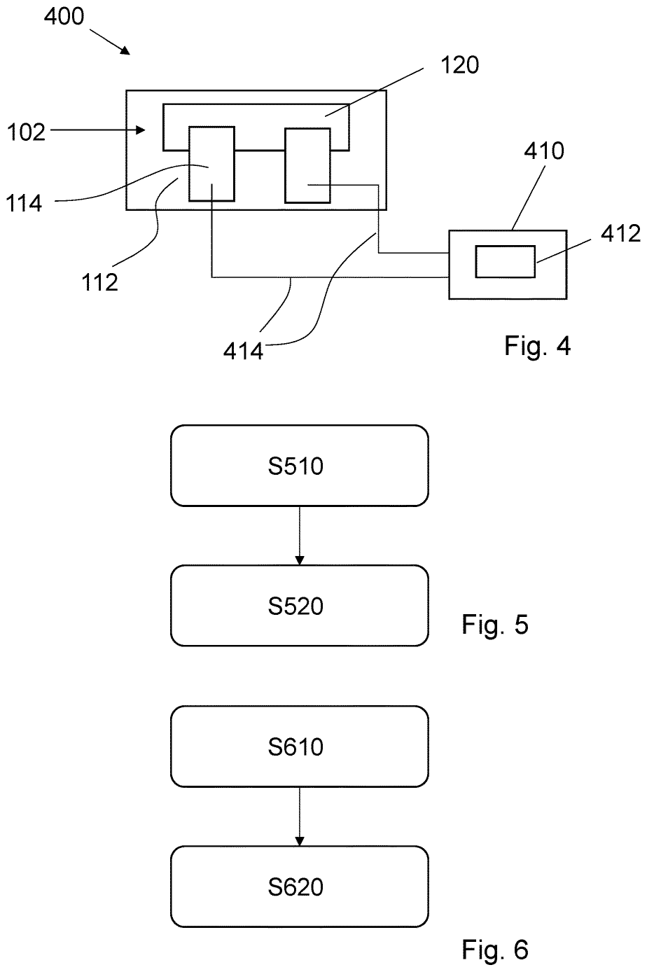

Referring to FIG. 4, a system 400 is shown. The system 400 comprises the aerosol generation device 100 (as described herein) and an auxiliary device 410.

The auxiliary device 410 is a discharge device, which is a device specifically configured to draw electrical current from the power supply 120.

The auxiliary device 410 is electrically connectable to the aerosol generation device 100 by forming an electrical connection with the conductive member arrangement 114 of the housing portion 112. This may be via the removable part of the housing portion 112 as described above, or otherwise. Importantly, the auxiliary device 410 may be electrically connected to the aerosol generation device 100 without removal of the housing portion 112.

In this example, the first electronic component 120 of the electronic component arrangement 102 is the power supply 120. The auxiliary device 410 comprises a first auxiliary device component 412. The first auxiliary device component may be a component arranged to receive (or draw) electrical current from the power supply 120. That is, the first auxiliary device component may be a discharge component. The discharge component may be a resistive load, or other suitable component. The auxiliary device 410 may comprise connectors 414 for forming an electrical connection with the conductive member arrangement 114, thereby to receive (or draw) electrical current from the power supply 120. In this way, the power supply 120 (in particular a battery cell) can be discharged without removal of the housing portion 112. This is advantageous in improving safety in a disassembly or recycling process.

In another example, the auxiliary device 410 could be formed integrally with the housing portion 112. That is, the housing portion 112 may be, or provide, an auxiliary device 410. In this way, the housing portion 112 is electrically connectable to the aerosol generation device 100 to facilitate discharging of the power supply 120. In such an example, an existing housing portion of the aerosol generation device 100 could be removed, and replaced with housing portion 112 comprising the auxiliary device 410. The housing portion 112 may electrically connected to the aerosol generation device 100, thereby to discharge the power supply 120.

Referring to FIG. 5, a method of providing an electrical connection in an aerosol generation device is schematically shown. The method may be a method of providing an electrical connection with an electronic component arrangement of an aerosol generation device.

The aerosol generation device comprised in the method may be the aerosol generation device 100 as described above.

The aerosol generation device comprises an electronic component arrangement; a first conductive element arrangement electrically connected to the electronic component arrangement; and a second conductive element arrangement electrically connected to the electronic component arrangement.

Optional Step S510 comprises providing the aerosol generation device, as described in the previous paragraph, or as described elsewhere herein.

Step S520 comprises configuring a conductive member arrangement formed as an integral part of a housing portion to provide an electrical connection between the first conductive element arrangement and the second conductive element arrangement.

The provision of the electrical connection may thereby provide an electrical connection with the electronic component arrangement by the conductive member arrangement of the housing portion.

Referring to FIG. 6, a method of disconnecting (e.g., removing) an electrical connection in an aerosol generation device is schematically shown.

The method may be a method of disconnecting (e.g., removing) an electrical connection with an electronic component arrangement of an aerosol generation device.

The aerosol generation device comprised in the method may be the aerosol generation device 100 as described above.

The aerosol generation device comprises an electronic component arrangement; a first conductive element arrangement electrically connected to the electronic component arrangement; and a second conductive element arrangement electrically connected to the electronic component arrangement

Optional Step S610 comprises providing the aerosol generation device, as described in the previous paragraph, or as described elsewhere herein.

Step S620 comprises removing a housing portion from the aerosol generation device, the housing portion comprising a conductive member arrangement formed as an integral part of the housing portion, wherein the conductive member arrangement is configured to provide an electrical connection between the first conductive element arrangement and the second conductive element arrangement, wherein removal of the housing portion thereby disconnects the electrical connection.

Viewed another way, removing the housing portion removes the electrical connection with the electronic component arrangement by the conductive member arrangement of the housing portion.

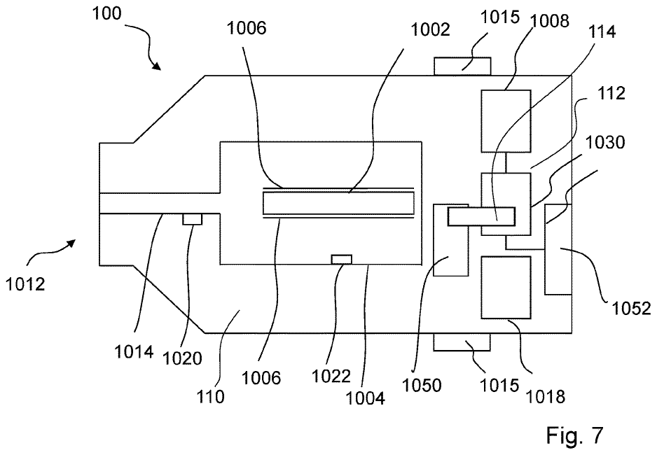

For more context, FIG. 7 shows a schematic cross-sectional view of an example aerosol generation device 100.

The aerosol generation device 100 may be any aerosol generation device 100 described above. That is, the aerosol generation device 100 described in relation to FIG. 7 may incorporate any or all of the features described above, as desired or as appropriate.

The aerosol generation device 100 is suitable for receiving a consumable 1002 therein. For example, the aerosol generation device 100 may include a chamber 1004 in which the consumable 1002 is received.

The invention is not limited to the specific aerosol generation device 100 or consumable 1002 described herein. That is, the description of the aerosol generation device 100 and consumable 1002 is provided for illustrative purposes only. The skilled person will appreciate that alternative constructions of aerosol generation devices and consumables will be compatible with the present invention.

A consumable 1002 comprises an aerosol substrate. The term aerosol substrate is a label used to mean a medium that generates an aerosol or vapour when heated. Aerosol substrate might be interpreted as an aerosol precursor. In one example, aerosol substrate is synonymous with smokable material, aerosol generation substrate and aerosol generation medium. Aerosol substrate includes materials that provide volatilized components upon heating, typically in the form of vapor or an aerosol. Aerosol substrate may be a non-tobacco-containing material or a tobacco-containing material. Aerosol substrate may, for example, include one or more of tobacco per se, tobacco derivatives, expanded tobacco, reconstituted tobacco, tobacco extract, homogenized tobacco or tobacco substitutes. Aerosol substrate also may include other, non-tobacco, products, which, depending on the product, may or may not contain nicotine. Aerosol substrate may comprise one or more humectants, such as glycerol or propylene glycol.

The aerosol generation device 100 may comprise one or more heaters 1006 configured to provide heat to the consumable 1002, in use.

In one example, the consumable 1002 contains a liquid and the one or more heaters comprises a heating element, such as a coil, a ceramic heater, a flat resistive heater, a mesh heater, a MEMS heater, or the like, configured to aerosolise the liquid for inhalation. A liquid delivery element or mechanism, such as a porous material, a capillary system, and/or valve, may transfer the liquid to the heating element, in use. In some examples, the aerosolised liquid may pass through a solid substrate within the aerosol generation device 100. In other examples, the consumable 1002 may comprise a solid aerosol substrate.

In one example, the aerosol generation device 100 comprises a nebulizing engine, such as a vibrating mesh, to generate an aerosol from a liquid with or without heating thereof.

The aerosol generation device 100 may comprise a mouthpiece 1012 through which a user draws on the aerosol generation device 100 to inhale generated aerosol. The mouthpiece 1012 includes a vent or channel 1014 that is connected to a region close to the consumable 1002 for passage of any generated aerosol from the consumable 1002, during use. For example, the channel 1014 may extend between an opening in the mouthpiece 1012 and the chamber 1004 in which the consumable 1002 is at least partially receivable. The mouthpiece 1012 is arranged such it may be received in a user's mouth in use. In other examples, a mouthpiece 1012 is not required and a portion of the consumable 1002 may protrude from the aerosol generation device 100. In this example, protruded portion of the consumable 1002 may work as mouthpiece.

The aerosol generation device 100 may comprise a control unit 1008 (or control circuitry) for electronic management of the device. The control unit 1008 may include a PCB or the like (not shown). The control unit 1008 is configured to control the one or more heaters 1006.

The aerosol generation device 100 may comprise an activation input sensor 1018. The activation input sensor 1018 may be a button, a touchpad, or the like for sensing a user's input, such as a tap or swipe. In other examples, the activation input sensor 1018 comprises a consumable sensor configured to detect if a consumable 1002 has been inserted into the aerosol generation device 100. For example, the input sensor 1018 may comprise an authenticity detector that is configured to detect if an authentic consumable 1002 has been inserted into the aerosol generation device 100. Additionally, or alternatively, the user input may also comprise an inhalation action by a user.

The aerosol generation device 100 may comprise a puff sensor 1020 (otherwise known as an inhalation sensor). The puff sensor 1020 is configured to detect an inhalation action (or puff) by a user on the aerosol generation device 100. In one example, the puff sensor 1020 comprises a microphone or a flow sensor configured to an airflow within the chamber 1004 and/or an airflow channel extending from the chamber 1004 through the mouthpiece 1012 to an inhalation outlet thereof, the airflow being associated with a user's inhalation action. In other examples, the puff sensor 1020 is configured to detect a change in pressure indicative of a beginning of an inhalation action on the aerosol generation device 100 by the user. In this case, the puff sensor 1020 may be located anywhere on the aerosol device 100 in which there would be a change in pressure due to an inhalation action of the user. In one example, the puff sensor 1020 is located in the channel 1014 between the chamber 1004 and the mouthpiece 1012 of the aerosol generation device 100. The puff sensor 1020 may also detect the end of an inhalation action by the user. For example, the puff sensor 1020 may be configured to detect a further change in pressure due to the end of an inhalation action of a user.

The aerosol generation device 100 may include one or more temperature sensors 1022 configured to directly or indirectly measure the temperature of the consumable 1002 in the aerosol generation device 100. The one or more temperature sensors 1022 may comprise a temperature sensor, such as a thermocouple or thermistor, configured to be located within or adjacent to the consumable 1002 when it is received in the aerosol generation device 100. For example, the one or more temperature sensors 1022 may be located within the chamber 1004 of the aerosol generation device 100. In other examples, the temperature of the consumable 1002 may be indirectly measured by the use of thermal imaging sensors. In further other example, the heater 1006 itself works as a temperature sensor if the heater 1006 has PTC (Positive Temperature Coefficient) or NTC (Negative Temperature Coefficient) characteristic.

The aerosol generation device 100 may include a power supply 1050 such as a battery cell. The power supply 1050 may be power supply 120 (in particular, the battery cell 120) described above. The power supply 1050 may comprise, or be, a battery module as described above. The power supply may provide the aerosol generation device 100 with electrical energy providing a voltage in the range of 3 V and 18 V, preferably in the range of 3 V and 4.2 V. In a preferred embodiment the voltage source (which may be the battery cell 110) is a lithium-ion secondary battery delivering a value of 3.7 V. Such a voltage source is particularly advantageous for a modern aerosol generation device in view of rechargeability, high energy density and large capacity. The power supply 1050 may provide power for operation of the aerosol generation device 100, for example the necessary power to generate aerosol. In an example, the power supply 1050 may provide power to one or more heaters 1006.

The aerosol generation device 100 may comprise a controller 1030. The controller 1030 is connected to the control unit 1008. The controller 1030 is configured to receive data from the control unit 1008. In particular, the controller 1030 is configured to receive data from the control unit 1008 relating to various sensors/inputs (such as the activation input sensor 1018, puff sensor 1020 and/or temperature sensor 1022) of the aerosol generation device 100.

The controller 1030 and the control unit 1008 may be integral with each other. In one example, a single component performs the function of the control unit 1008 and controller 1030. In other examples, the control unit 1008 and the controller 1030 are distinct components.

As above, the battery module 120 may comprise one or more battery module components, and the battery module 120 may comprise a visual indicator 150 arranged to indicate a battery module component characteristic.

Furthermore, the aerosol generation device 100 of FIG. 7 may comprise a housing portion 112 comprising a conductive member arrangement 114, wherein the conductive member arrangement 114 is configured to be connected between a first conductive element arrangement and a second conductive element arrangement, such that an electrical connection is provided with an electronic component arrangement (in this example between power supply 1050 and the controller 1030) by the conductive member arrangement 114 of the housing portion 112.

The aerosol generation device 100 may comprise a USB port 1052 (e.g., a USB receiving port). The USB port may provide connection to the controller 1030.

It will be appreciated that the invention that has been described and defined above may allow the related apparatus and methods to drive, comply with, or more easily comply with, legal and regulatory requirements, guidelines and standards. In particular, this might be in relation to one or more of apparatus (e.g. battery or related device) inspection, indication/status, recycling, reuse, repair, replacement, and maintenance, whether by an end user or service provider.

Referring generally to the description herein, further detail is hereby provided in relation to terms used above and features described in the present disclosure, or to further terms relevant to the present disclosure:
A “battery” may mean any device delivering electrical energy generated by direct conversion of chemical energy, having internal or external storage, and consisting of one or more non-rechargeable or rechargeable battery cells or modules thereof, and includes a battery that has been subject to preparation for re-use, preparation for repurposing, repurposing or remanufacturing;
A “battery module” may mean one or more battery module components (e.g., any set of one or more battery cells and/or one or more other components, as described above) that are connected together or encapsulated within an outer casing, housing, surround, envelope, wrapping, or the like, to protect the cells against internal impact, and which is meant to be used either alone or in combination with other modules. In some examples, a “battery module” within the context of this specification may otherwise be known as a “battery pack”;
A “battery cell” may mean the basic functional unit in a battery, composed of electrodes, electrolyte, container, terminals, and, if applicable, separators, and containing the active materials the reaction of which generates electrical energy;
An “active material” means a material which reacts chemically to produce electric energy when the battery cell discharges or to store electric energy when the battery is being charged.

Although preferred embodiments have been shown and described, it will be appreciated by those skilled in the art that various changes and modifications might be made without departing from the scope of the invention, as defined in the appended claims and as described above.

1. An aerosol generation device comprising:
an electronic component arrangement comprising a power supply and a component to be provided with electrical power from the power supply;
a first conductive element arrangement electrically connected to the electronic component arrangement;
a second conductive element arrangement electrically connected to the electronic component arrangement; and
a housing portion comprising a conductive member arrangement formed as an integral part of the housing portion, wherein the conductive member arrangement is configured to provide an electrical connection between the first conductive element arrangement and the second conductive element arrangement,
wherein the housing portion is removably attachable to the aerosol generation device to close or cover an outer surface, or part of an outer surface, of the aerosol generation device,
wherein the housing portion is configured to be removable from the aerosol generation device to:
disconnect the electrical connection between the first conductive element arrangement and the second conductive element arrangement; and
provide access to the power supply for removal and/or replacement thereof.

2. The aerosol generation device according to claim 1, wherein the electronic component arrangement comprises a first electronic component and a second electronic component, the first conductive element arrangement is electrically connected to the first electronic component, and the second conductive element arrangement is electrically connected to the second electronic component, wherein the conductive member arrangement of the housing portion is configured to be connected between the first conductive element arrangement and the second conductive element arrangement, such that an electrical connection is provided between the first electronic component and the second electronic component by the conductive member arrangement of the housing portion.

3. The aerosol generation device according to claim 2, wherein the first electronic component is the power supply or the component to be provided with electrical power from the power supply and/or the second electronic component is the power supply or the component to be provided with electrical power from the power supply.

4. The aerosol generation device according to claim 1, wherein the first conductive element arrangement comprises a first pair of conductive elements, the second conductive element arrangement comprises a second pair of conductive elements, and the conductive member arrangement comprises a pair of conductive members, wherein:
a first one of the pair of conductive members is connectable between a first one of the first pair of conductive elements and a first one of the second pair of conductive elements; and
a second one of the pair of conductive members is connectable between a second one of the first pair of conductive elements and a second one of the second pair of conductive elements.

5. The aerosol generation device according to claim 1, wherein the conductive member arrangement of the housing portion is configured to form a part of an electrical circuit of the aerosol generation device.

6. The aerosol generation device according to claim 1, wherein the conductive member arrangement of the housing portion is configured to form a part of an electrical circuit of a battery module of the aerosol generation device.

7. The aerosol generation device according to claim 6, wherein the housing portion forms part of the battery module of the aerosol generation device.

8. The aerosol generation device according to claim 1, wherein the conductive member arrangement of the housing portion is configured to provide the electrical connection to enable operation of one or more components of the electronic component arrangement of the aerosol generation device.

9. A method of disconnecting an electrical connection in an aerosol generation device, the aerosol generation device comprising:
an electronic component arrangement comprising a power supply and a component to be provided with electrical power from the power supply;
a first conductive element arrangement electrically connected to the electronic component arrangement;
a second conductive element arrangement electrically connected to the electronic component arrangement; and
a housing portion comprising a conductive member arrangement formed as an integral part of the housing portion, wherein the conductive member arrangement is configured to provide an electrical connection between the first conductive element arrangement and the second conductive element arrangement, wherein the housing portion is removably attachable to the aerosol generation device to close or cover an outer surface, or part of an outer surface, of the aerosol generation device, the method comprising:
removing the housing portion from attachment to the aerosol generation device to:
disconnecting the electrical connection between the first conductive element arrangement and the second conductive element arrangement; and
providing access to the power supply for removal and/or replacement thereof.

10-15. (canceled)
